(19) United States
(12) Patent Application Publication
(10) Pub. No.: US 2017/0118728 A1
(43) Pub. Date: Apr. 27, 2017

(54) USER TERMINAL, RADIO BASE STATION AND RADIO COMMUNICATION METHOD

(71) Applicant: NTT DOCOMO, INC., Tokyo (JP)

(72) Inventors: Hiroki Harada, Tokyo (JP); Kazuki Takeda, Tokyo (JP); Tooru Uchino, Tokyo (JP); Satoshi Nagata, Tokyo (JP)

(73) Assignee: NTT DOCOMO, INC., Tokyo (JP)

(21) Appl. No.: 15/127,186

(22) PCT Filed: Mar. 13, 2015
(86) PCT No.: PCT/JP2015/057499

§ 371 Date: Sep. 19, 2016

(30) Foreign Application Priority Data
Mar. 19, 2014 (JP) 2014-056967

(51) Int. Cl. H04W 52/38; H04W 72/14; H04W 72/04; H04W 16/14

(52) U.S. Cl. CPC H04W 52/38; H04W 16/14; H04W 72/14; H04W 72/0413; H04W 72/0453; H04W 72/0473

(57) ABSTRACT

The present invention is designed to apply UL transmission control adequately in a radio communication system which runs LTE in an unlicensed band (LTE-U). A user terminal communicates with a radio base station by using a licensed band and an unlicensed band, and has a detection section that detects a signal transmitted from another transmission point in the unlicensed band, a control section that controls transmission of a UL signal in the unlicensed band based on a UL transmission command transmitted from the radio base station and the detection result in the detection section, and a transmission section that transmits the UL signal, and the transmission section transmits information related to the detection result to the radio base station by using the licensed band.

### TECHNICAL FIELD

The present invention relates to a radio base station, a user terminal and a radio communication method that are applicable to a next-generation communication system.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). In LTE, as multiple-access schemes, a scheme that is based on OFDMA (Orthogonal Frequency Division Multiple Access) is used in downlink channels (downlink), and a scheme that is based on SC-FDMA (Single Carrier Frequency Division Multiple Access) is used in uplink channels (uplink). Also, a successor system of LTE (referred to as, for example, “LTE-advanced” or “LTE enhancement” (hereinafter referred to as “LTE-A”)) has been developed for the purpose of achieving further broadbandization and increased speed beyond LTE, and the specifications thereof have been drafted (Re. 10/11).

For future radio communication systems (Rel. 12 and later versions), a system (LTE-U: LTE Unlicensed) is under study, which allows LTE systems run not only in frequency bands licensed to communications providers (operators) (licensed bands), but also in frequency bands that require no license (unlicensed bands). A licensed band refers to a band, in which a specific provider is allowed exclusive use, and an unlicensed band refers to a band, which is not limited to a specific provider, and in which radio stations can be provided. For unlicensed bands, for example, the 2.4 GHz band and the 5 GHz band where Wi-Fi and Bluetooth (registered trademark) can be used, the 60 GHz band where millimeter-wave radars can be used, and so on are under study for use.

### CITATION LIST

### Non-Patent Literature

Non-Patent Literature 1: 3GPP TS 36. 300 “Evolved UTRA and Evolved UTRAN Overall Description”

### SUMMARY OF INVENTION

### Technical Problem

Existing LTE presumes operation in licensed bands, and therefore each operator is allocated a different frequency band. However, unlike a licensed band, an unlicensed band is not limited to use by a specific provider. Consequently, there is a possibility that the frequency band which a given operator uses in LTE-U overlaps the frequency band that another operator uses for LTE-U and/or Wi-Fi. Furthermore, in unlicensed bands, not only operators, but also non-operators (for example, individuals, people of companies that are not licensed radio communications providers, and so on) might set up radio base stations that use LTE-U (LTE-U base stations).

When LTE runs in an unlicensed band, this operation may be carried out without even synchronization, coordination and/or cooperation between different operators and/or non-operators. In this case, a plurality of operators and/or the like share and use the same frequency in the unlicensed band, and therefore there is a threat of producing mutual interference.

So, Wi-Fi systems that run in unlicensed bands employ carrier sense multiple access/collision avoidance (CSMA/CA), which is based on the mechanism of LBT (Listen Before Talk). To be more specific, for example, a method, whereby each transmission point (AP (Access Point)) performs “listening” (CCA: Clear Channel Assessment) before carrying out transmission and carries out DL transmission only when there is no signal beyond a predetermined level, is used.

Similarly, in LTE-U, too, a method, in which a user terminal performs listening (LBT) to the unlicensed band and controls UL transmission (including, for example, stopping UL transmission for a predetermined period of time) based on the result of this listening, may be employed. However, in LTE systems, user terminals transmit UL data signals (PUSCH signals) based on UL transmission commands (UL grants) from radio base stations. Consequently, when a user terminal controls the transmission of UL signals based on the result of LBT, cases might occur where the situation the user terminal is in cannot be learned accurately on the radio base station side, and therefore unnecessary UL transmission control (for example, adaptive control such as retransmission operation and so on) may be produced.

The present invention has been made in view of the above, and it is therefore an object of the present invention to provide a user terminal, a radio base station and a radio communication method to allow adequate UL transmission control in a radio communication system which runs LTE in an unlicensed band (LTE-U).

### Solution to Problem

A user terminal, according to an aspect of the present invention, is a user terminal to communicate with a radio base station by using a licensed band and an unlicensed band, and this user terminal has a detection section that detects a signal transmitted from another transmission point in the unlicensed band, a control section that controls transmission of a UL signal in the unlicensed band based on a UL transmission command transmitted from the radio base station and the detection result in the detection section, and a transmission section that transmits the UL signal, and the transmission section transmits information related to the detection result to the radio base station by using the licensed band.

### Advantageous Effects of Invention

According to one aspect of the present invention, UL transmission control can be applied adequately in a radio communications system (LTE-U) which runs LTE in an unlicensed band.

### BRIEF DESCRIPTION OF DRAWINGS

FIG. 1 provide diagrams to show examples of modes of operation in the event LTE is used in an unlicensed band;

FIG. 2 is a diagram to explain an example case where LBT is supported in UL transmission in LTE-U;

FIG. 3 is a diagram to explain another example case where LBT is supported in UL transmission in LTE-U;

FIG. 4 provide diagrams to explain other example cases where LBT is supported in UL transmission in LTE-U;

FIG. 5 is a diagram to explain an example method of transmitting the results of LBT performed by a user terminal with respect to an unlicensed band, by using a licensed band;

FIG. 6 is a diagram to show examples of UL/DL configurations employed in LTE TDD;

FIG. 7 is a diagram to explain another example method of transmitting the results of LBT performed by a user terminal with respect to an unlicensed band, by using a licensed band;

FIG. 8 is a diagram to explain another example method of transmitting the results of LBT performed by a user terminal with respect to an unlicensed band, by using a licensed band;

FIG. 9 is a diagram to show an example of UL transmission power control in the event LBT is supported in UL transmission in LTE-U;

FIG. 10 is a diagram to show an example method of controlling UL transmission power depending on LBT results in UL transmission in LTE-U;

FIG. 11 is a schematic diagram to show an example of a radio communication system according to the present embodiment;

FIG. 12 is a diagram to explain an overall structure of a radio base station according to the present embodiment;

FIG. 13 is a diagram to explain a functional structure of a radio base station according to the present embodiment;

FIG. 14 is a diagram to explain an overall structure of a user terminal according to the present embodiment; and

FIG. 15 is a diagram to explain a functional structure of a user terminal according to the present embodiment.

### DESCRIPTION OF EMBODIMENTS

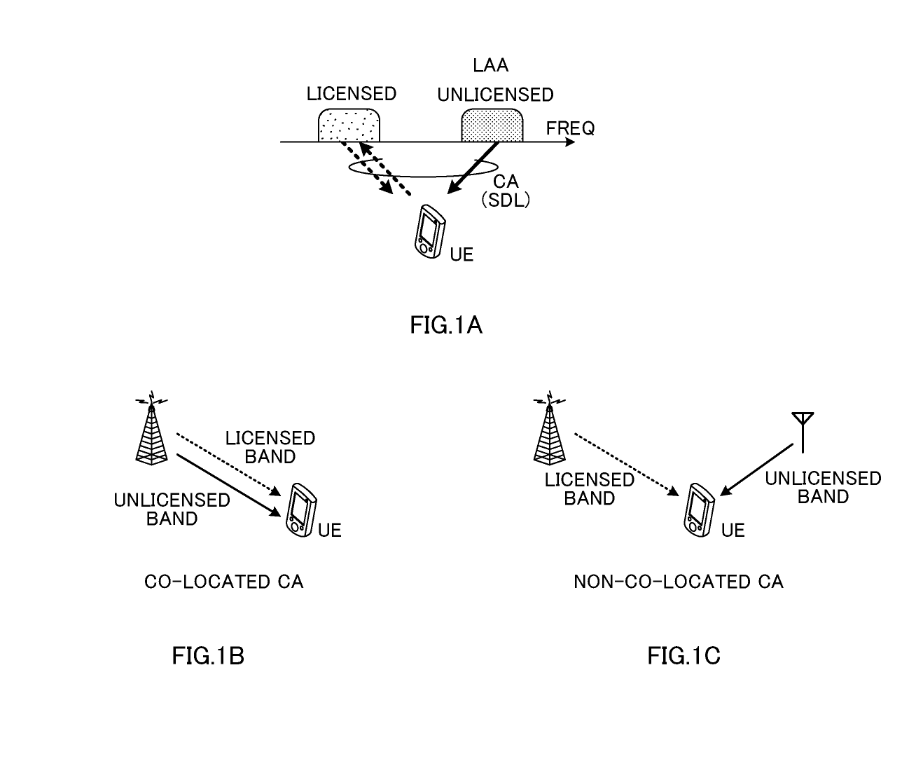

FIG. 1 show modes of operation for a radio communication system (LTE-U) that may be applicable with the present embodiment. FIG. 1A illustrates a case in which carrier aggregation (CA) is executed by using a licensed band and an unlicensed band.

Carrier aggregation (CA) refers to bundling a plurality of component carriers (also referred to as “CCs,” “carriers,” “cells,” etc.) into a wide band. Each CC has, for example, a bandwidth of maximum 20 MHz, so that, if maximum five CCs are bundled, a wide band of maximum 100 MH can be achieved.

When CA is employed, one radio base station's scheduler controls the scheduling of a plurality of CCs. From this, CA may be referred to as “intra-base station CA” (intra-eNB CA). Also, referring to FIG. 1A, the unlicensed band may be used as a supplemental downlink (SDL). A supplemental downlink refers to a carrier (band) that is used exclusively for DL communication.

According to the present embodiment, as shown in FIG. 1B, a DL signal of a licensed band and a DL signal of an unlicensed can be transmitted from one transmission point (for example, a radio base station) (co-located CA). In this case, an LTE-U base station can communication with user terminals by using the licensed band and the unlicensed band.

Alternatively, as shown in FIG. 1C, it is equally possible to transmit a DL signal of a licensed band and a DL signal of an unlicensed band from different transmission points, separately (non-co-located CA). In this case, it is possible to transmit one DL signal (for example, the DL signal of the licensed band) from a radio base station, and transmit the other DL signal (for example, the DL signal of the unlicensed band) from an RRH (Remote Radio Head) that is connected to the radio base station. In this case, a structure to connect between a transmission point to use the licensed band and a transmission point to use the unlicensed band with a backhaul link (for example, optical fiber and so on) may be used.

Also, as shown in FIG. 1, in the operation of LTE-U, unlicensed LTE (LTE-unlicensed) that presumes the presence of LTE in a licensed band (licensed LTE) is also referred to as “LAA” (Licensed-Assisted Access). When licensed LTE and unlicensed LTE are coordinated to communicate with a user terminal, information about communication in the unlicensed band can be reported to the user terminal by using the licensed band.

Also, in the modes of operation shown in above FIG. 1, for example, the licensed band CC can be used as the primary cell (PCell), and the unlicensed band CC can be used as a secondary cell (SCell). Here, the primary cell (PCell) refers to the cell to manage RRC connection, handover and so on when CA is executed, and is also a cell that requires UL communication in order to receive data and feedback signals from terminals. When CA is executed, the primary cell is always configured in the uplink and the downlink. A secondary cell (SCell) refers to another cell that is configured apart from the primary cell when CA is employed. A secondary cell may be configured in the downlink alone, or may be configured in both the uplink and the downlink at the same time.

Now, unlike a licensed band, an unlicensed band is not limited to use by a specific communications provider (operator). Generally speaking, assuming there are varying operators, it is difficult to allow an operator to control another operator's cell planning (cell arrangement). Furthermore, in an unlicensed band, it might occur that non-operators (for example, individuals, people of companies that are not licensed radio communications providers, and so on), apart from the operators providing services in licensed bands, might set up LTE-U base stations.

Also, it might occur that varying operators and non-operators run LTE-U base stations, Wi-Fis and so on without even establishing synchronization, coordination and/or cooperation between them. In such cases, there is a possibility that the same frequency or neighboring frequencies are used in different operators' LTE-U and Wi-Fi systems, making mutual interference a significant problem.

Consequently, in unlicensed bands, transmission control (which includes stopping transmission, controlling transmission timings and so on) based on the mechanism of LBT (Listen Before Talk) may be employed in order to reduce interference with other systems. Here, the LBT mechanism refers to the kind of operation to perform listening (LBT) before transmitting DL signals, and detect/measure DL signals that are transmitted from other access points. Each transmission point applies transmission control (including, for example, stopping transmission) depending on detection results (LBT results).

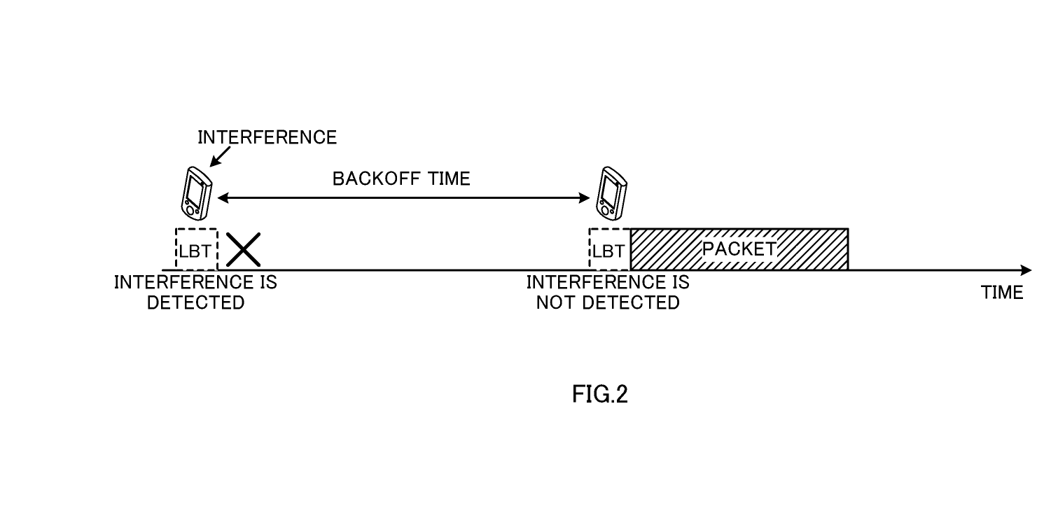

In Wi-Fi systems, transmission control based on the LBT mechanism is introduced. To be more specific, in Wi-Fi systems, before DL transmission is carried out, listening (LBT) is performed in the frequency where the transmission is planned (see FIG. 2). If, as a result of listening, an interfering signal from another communication system (another operator's LTE-U, Wi-Fi and so on) is detected (that is, interference is detected), the signal transmission is cancelled, and, after a predetermined period of time, LBT is performed again (LBT+random backoff). Also, if, as a result of listening, no interfering signal from other communication systems is detected (that is, interference is not detected), the signal transmission is carried out. Noe that LBT may be performed in a predetermined cycle (for example, every several ms).

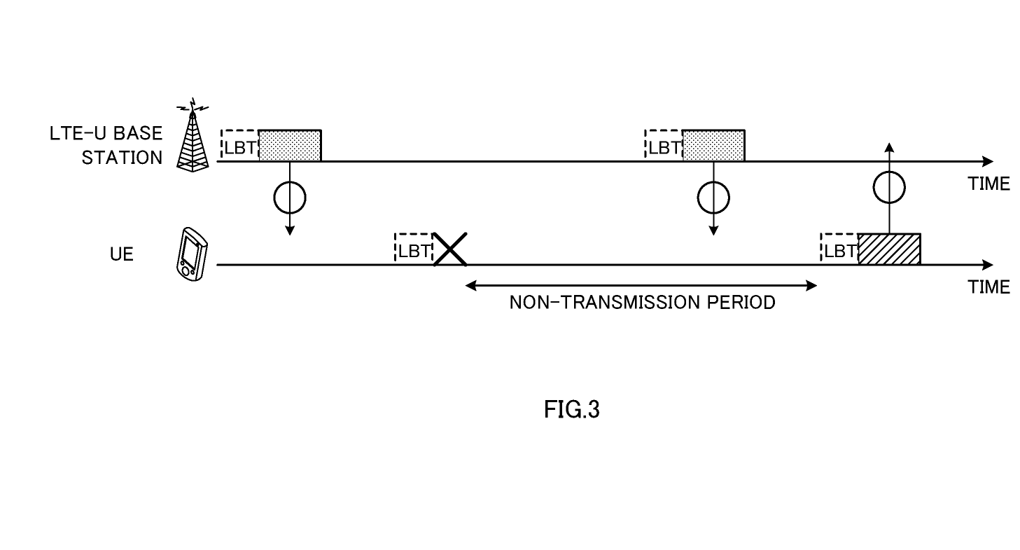

So, in LTE-U systems, too, as in Wi-Fi systems, transmission control that is based on the LBT mechanism (LBT+random backoff) may be applied (see FIG. 3). In DL, a radio base station performs LBT before transmitting a DL signal (for example, the PDCCH signal, the PDSCH signal and so on) in an unlicensed band, and controls the DL transmission depending on the result of this LBT. In turn, in UL, a user terminal performs LBT before transmitting a UL signal (for example, the PUSCH signal) in the unlicensed band, and controls the UL transmission depending on the result of this listening.

Note that the downlink in FIG. 3 illustrates a case where the results of LBT, performed twice by a radio base station in an unlicensed band, show that interference is not detected (suitable for transmission), and DL signals (for example, PDCCH signals) are transmitted. Also, the uplink in FIG. 3 illustrates a case where the result of the first LBT performed by a user terminal in the unlicensed band shows that interference is detected (not suitable for transmission), and the transmission of a UL signal (for example, the PUSCH signal) is stopped, and where the second LBT result shows that interference is not detected (suitable for transmission) and a UL signal (for example, the PUSCH signal) is transmitted.

However, in LTE systems, user terminals transmit UL signals (for example, PUSCH signals) based on UL transmission commands (UL grants) contained in downlink control information (DCI) from radio base stations. To be more specific, when a user terminal receives a downlink control signal (UL grant) transmitted from a radio base station, the user terminal transmits a UL data signal in a subframe that comes a predetermined period of time later (for example, 4 ms later). This is a point of difference from the UL transmission operation in Wi-Fi systems (random access-based) where terminals carry out transmission autonomously.

Consequently, in the event LBT is supported in an unlicensed band (LAA) in LTE-U, if a user terminal receive a downlink control signal and detects a UL grant therein, the user terminal then performs LBT a predetermined period of time later, and transmits a UL data signal if the result of LBT shows that interference is not detected (hereinafter also phrased as “suitable for transmission”). On the other hand, when the result of LBT shows that interference is detected (hereinafter also phrased as “not suitable for transmission”), the user terminal cancels the transmission of the UL data signal. Under this circumstance, cases might occur where no UL data signal is transmitted even when a UL grant is received properly on the user terminal side.

In existing LTE systems, when no UL data signal is transmitted from a user terminal where UL transmission is commanded, a radio base station understands that the user terminal does not transmit UL data signals (PUSCH signals) because the user terminal is unable to detect UL grants (DTX). DTX refers to the case in which the quality of communication is poor, and which the radio base station judges as being equivalent to a “NACK,” and applies adaptive control in order to secure quality.

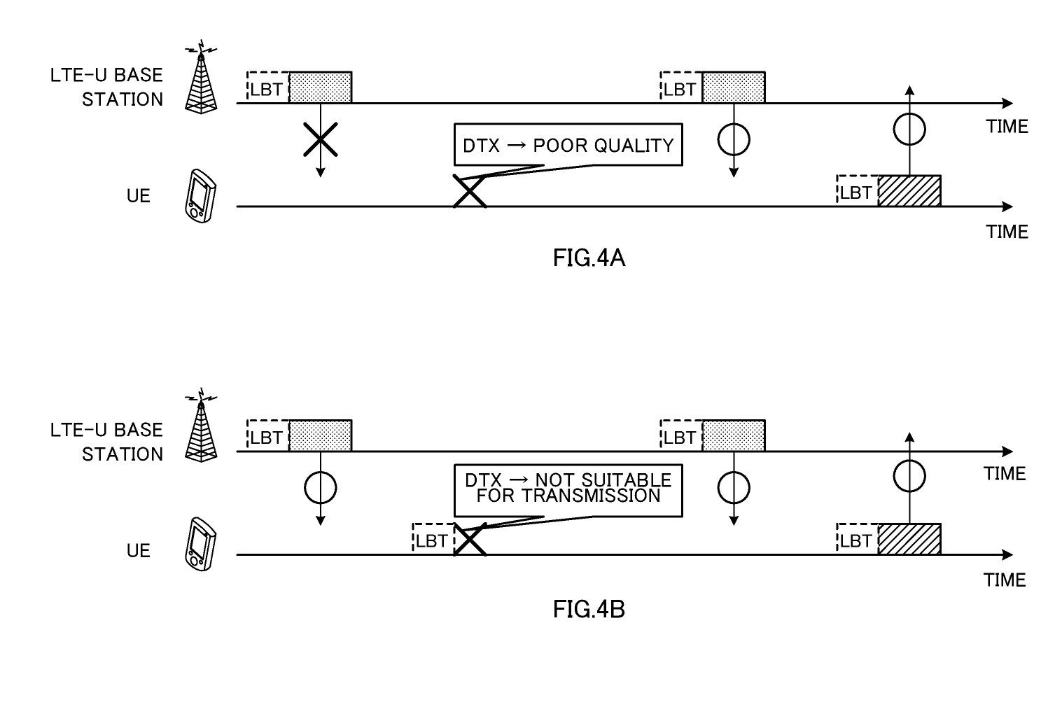

On the other hand, as shown in FIG. 3 above, when a user terminal controls transmissions in an unlicensed band depending on LBT results, there is a threat that a radio base station identifies “DTX” even when a UL grant is received properly on the user terminal side. That is, when LBT is supported in UL communication in LTE-U, there may be two types of DTX—namely, the case where a user terminal fails to receive downlink control information (UL grant) (see FIG. 4A) and the case where downlink control information is received properly but the result of LBT nevertheless says “not suitable for transmission” (see FIG. 4B).

The DTX shown in FIG. 4A arises from the user terminal's failure to receive a UL grant, as in conventional cases, and the radio base station applies adaptive control in order to secure quality. On the other hand, referring to the DTX shown in FIG. 4B, the radio base station does not have to apply adaptive control because a UL grant is successfully received in the user terminal, and it is preferable to apply control (which includes, for example, changing the frequency to use and so on) that is different from that applied in the case of DTX shown in FIG. 4A.

So, the present inventors have found out that, by allowing a radio base station to control UL transmissions based on the result of LBT performed by a user terminal, the radio base station can spare unnecessary adaptive control even when judging that the user terminal is in the DTX state. Also, the present inventors have focused on the fact that, in LAA, when a user terminal uses an unlicensed band cell, the user terminal is connected to a licensed band cell where LBT is not performed. That is, the present inventors have focused on the fact that, even when LBT yields a result that says “not suitable for transmission” and UL transmission is stopped in the unlicensed band, the user terminal can still transmit UL signals in the licensed band, and come up with the idea of reporting information related to the LBT result to a radio base station by using the licensed band.

By this means, even when LBT is supported in UL communication in LTE-U, it becomes possible, on the radio base station side, to learn the accurate reason (the type of DTX) no UL transmission is carried out form a user terminal where UL transmission is commanded. As a result of this, the radio base station can apply adequate UL transmission control to the user terminal.

Also, LBT results that are reported from the user terminal can be reported to the radio base station as part of a physical channel of the licensed band, a reference signal, a MAC CE or a measurement report. Furthermore, LBT results may be reported from the user terminal to the radio base station only when transmission is not suitable, or may be reported both when transmission is suitable and when transmission is not suitable.

Now, the present embodiment will be described below in detail with reference to the accompanying drawings.

### First Example

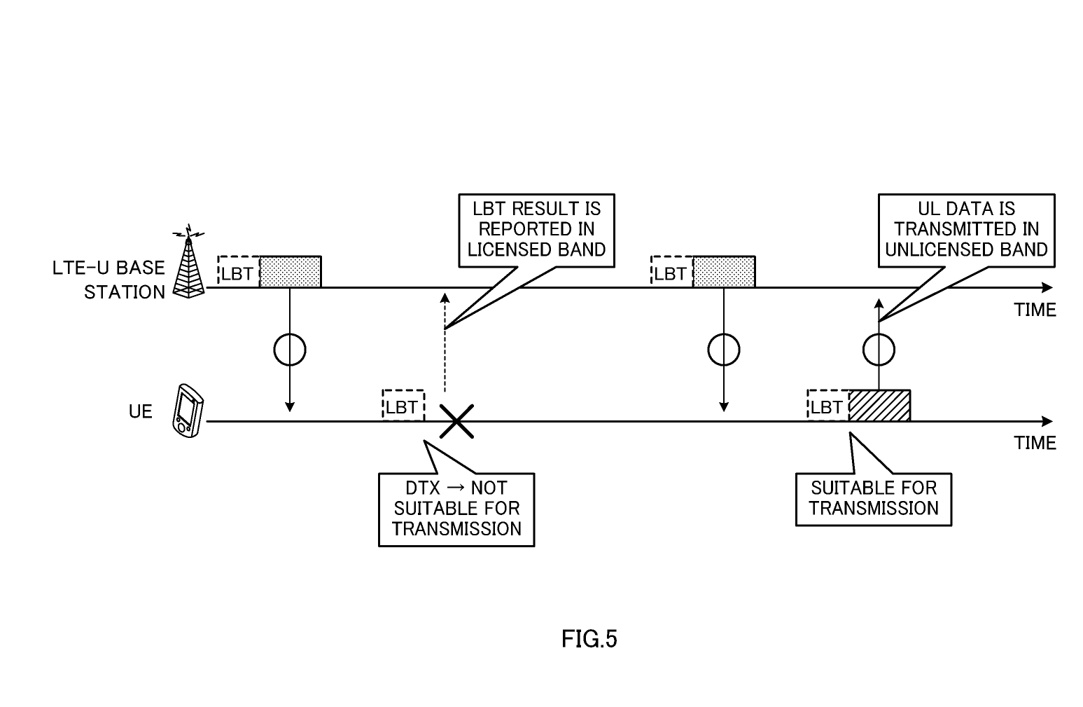

A case will be described with a first example where the results of LBT performed by a user terminal in an unlicensed band are reported by using a licensed band physical channel, reference signal and so on (see FIG. 5).

Referring to FIG. 5, when the user terminal receives downlink control information (UL grant) properly in an unlicensed band, the user terminal performs LBT before transmitting a UL data signal. If the result of LBT says “suitable for transmission,” the user terminal transmits a UL data signal based on the command of the UL grant. On the other hand, if the result of LBT says “not suitable for transmission,” the user terminal does not transmit a UL data signal, and transmits information related to the LBT result (“not suitable for transmission”) to the radio base station by using a physical channel, a reference signal and so on of a licensed band.

For the physical channel, an uplink control channel (PUCCH), a random access channel (PRACH), an uplink shared channel (PUSCH) and so on can be used, and, for the reference signal, an uplink measurement reference signal (SRS), a channel state measurement reference signal (CSI) and so on can be used.

When the result of LBT performed by the user terminal is reported using a physical resource such as the PUCCH, the PRACH, the SRS and so on, whether the LBT result is “suitable for transmission” or “not suitable for transmission” can be reported in one bit or two bits of information. In this case, the user terminal transmits this information about the result of LBT in a predetermined timing after LBT (in a predetermined subframe).

Note that, when the user terminal reports the result of LBT by using a physical resource such as the PUCCH, the PRACH, the SRS and so on, this physical resource is reported from the radio base station to the user terminal through higher layer signaling (for example, RRC signaling). Alternatively, the radio base station can indicate this to the user terminal by using a UL grant in the PUSCH in the unlicensed band.

Also, when the user terminal reports the result of LBT by using a physical resource of periodic CSI in the licensed band, part of the information of the CSI resource may be replaced by the LBT result. Also, the user terminal sends the report by using periodic CSI that is transmitted in a predetermined timing after LBT (for example, in the subframe that comes 4 ms later). Depending on the payload size of the CSI, the LBT result may be reported in greater detail.

Also, when the user terminal reports the result of LBT by using a physical resource of the PUSCH, the LBT result is multiplexed over the PUSCH of the licensed band in the same timing as the UL transmission timing specified by the UL grant of the unlicensed band (LAA). A structure may be employed here in which, if no licensed band PUSCH transmission is commanded (UL grant) in this timing, the user terminal does not report the LBT result. Now, cases of reporting LBT results by using the PUCCH, the SRS and the PUSCH will be described below in greater detail.

<PUCCH>

When a user terminal transmits a result of LBT in an unlicensed band by using the PUCCH of a licensed band, the user terminal feeds back the LBT result in a predetermined timing. For example, when the result of LBT says “not suitable for transmission,” the user terminal transmits the LBT result, by using the PUCCH of the licensed band, in the subframe timing (for example, in the subframe that comes 4 ms later) where the user terminal originally planned to transmit the LBT result in the unlicensed band if the LBT result was “suitable for transmission.”

That is to say, according to the present embodiment, if a UL grant is received properly and the LBT result says “suitable for transmission,” the user terminal transmits UL data using the unlicensed band, and, if the LBT result says “not suitable for transmission,” the user terminal stops transmitting UL data in the unlicensed band and furthermore reports the LBT result by using the licensed band.

Usually, when no UL data signal is transmitted from a user terminal to which a UL grant has been transmitted, the radio base station judges this case as “DTX.” However, with the present embodiment, the radio base station can judge that the UL unlicensed band is “not suitable for transmission” by detecting the licensed band PUCCH in which the LBT result is included. By this means, the radio base station can learn, accurately, whether transmission is suitable/transmission is not suitable for the user terminal in the unlicensed band, and schedule UL signals adequately.

Also, the PUCCH transmission timing in the event the result of LBT says “not suitable for transmission” is made the same as a UL transmission timing (UL grant command) in the unlicensed band, so that it is possible to prevent the scheduling control from being complex. Furthermore, since transmission in the licensed band is also carried out in the UL transmission timing of the unlicensed band, it becomes possible to apply the same mechanism (UL transmission mechanism) to half-duplex terminals that cannot transmit and receive at the same time.

Note that the present embodiment is applicable to both frequency division duplex (FDD), in which the uplink (UL) and the downlink (DL) are divided based on frequency, and time division duplex (TDD), in which the uplink and the downlink are divided based on time.

For example, assume a case where a licensed band is configured as an FDD cell and an unlicensed band (LAA) is configured as a TDD cell, and where a user terminal transmits a result of LBT (for example, “not suitable for transmission”) performed in the unlicensed band, by using the licensed band. In this case, the radio base station configures the UL/DL configuration to use in TDD in the unlicensed band in the user terminal. The user terminal can control the transmission timing of the LBT result, which is transmitted in the licensed band (FDD), based on a UL subframe (PUSCH transmission timing) of the TDD UL/DL configuration.

That is, if the result of LBT says “not suitable for transmission,” the user terminal transmits the LBT result, by using the PUCCH of the licensed band (FDD), in the subframe timing where the user terminal originally planned to transmit the LBT result in a UL subframe of the unlicensed band (TDD) if the LBT result was “suitable for transmission.” Note that the subframe timing where the LBT result was planned to be transmitted in a UL subframe of the unlicensed band (TDD) is determined per UL/DL configuration configured in the user terminal.

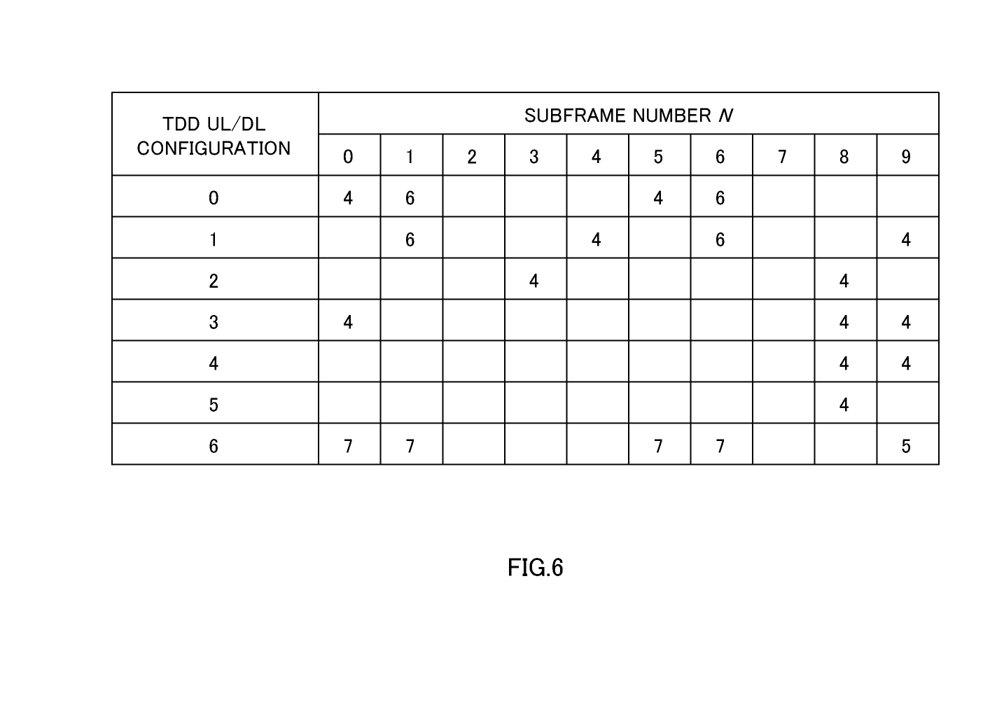

FIG. 6 shows UL/DL configurations that can be used in the present embodiment. For example, assume a case where UL/DL configuration 2 is configured in a user terminal. In this case, the PUSCH signal transmission that is commanded by the UL grant transmitted in subframe 3 via the unlicensed band is carried out in subframe 7. Similarly, the PUSCH signal transmission that is commanded by the UL grant transmitted in subframe 8 is carried out in subframe 2.

Consequently, when the user terminal reports a result of LBT in the unlicensed band by using the PUCCH of the licensed band, the user terminal sends this report in the same timing as a timing where a UL data signal was planned to be transmitted in the unlicensed band. For example, the user terminal sends information related to the LBT result (“not suitable for transmission”) of the UL data signal that is specified by the UL grant transmitted in subframe 3 in the unlicensed band, in the PUCCH of the licensed band in subframe 7. By this means, it is possible to prevent the scheduling control from being complex.

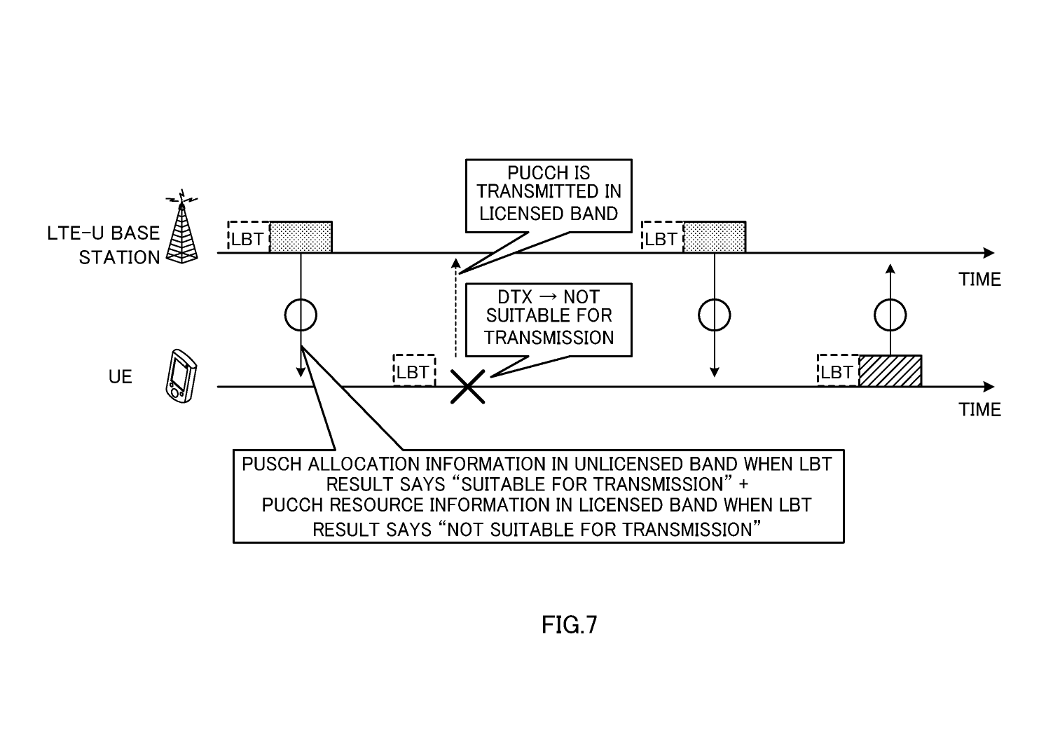

Now, as described above, when a result of LBT is transmitted using the PUCCH of a licensed band, how to determine the PUCCH resource to allocate this LBT result is the problem. So, with the present embodiment, the PUCCH resource for reporting the LBT result can be indicated to a user terminal by using a UL grant that commands PUSCH transmission in an unlicensed band (see FIG. 7). The user terminal, for example, specifies the licensed band PUCCH resource for reporting the LBT result by using an information bit contained in the UL grant of the unlicensed band. Alternatively, the user terminal may specify the licensed band PUCCH resource for reporting the LBT result by using information (the resource index, the aggregation level, and so on) that is acquired upon detecting the unlicensed band UL grant.

That is, when the LBT result says “suitable for transmission,” the user terminal allocates a UL data signal to the PUSCH of the unlicensed band based on PUSCH allocation information for the unlicensed band. On the other hand, if the LBT result says “not suitable for transmission,” the user terminal allocates information related to the LBT result to the PUCCH of the licensed band by using the UL grant of the unlicensed band.

In this way, the PUCCH resources in a licensed band for allocating LBT results are determined by using information that is included in downlink control information (for example, UL grant) of an unlicensed band, so that it is possible to schedule, dynamically, the PUCCH for reporting LBT results.

Alternatively, it is equally possible to report, in advance, LBT-reporting PUCCH resources to a user terminal through higher layer signaling (for example, RRC signaling). In this case, the user terminal reports LBT results by using periodic resources that are configured by RRC signaling, as when sending scheduling requests and/or CSI reports. For example, the user terminal may use part of the bits for reporting periodic CSI as bits for reporting LBT results. Alternatively, it is equally possible to newly add resource for reporting LBT results to the PUCCH of the licensed band.

In this way, PUCCH resources for reporting LBT results are reported to user terminals through higher layer signaling, so that it is possible to reduce the increase of the payload size of UL grants. Also, it becomes possible to prevent UL grant resource constraints from being produced, and allocate PUCCH resources.

<SRS>

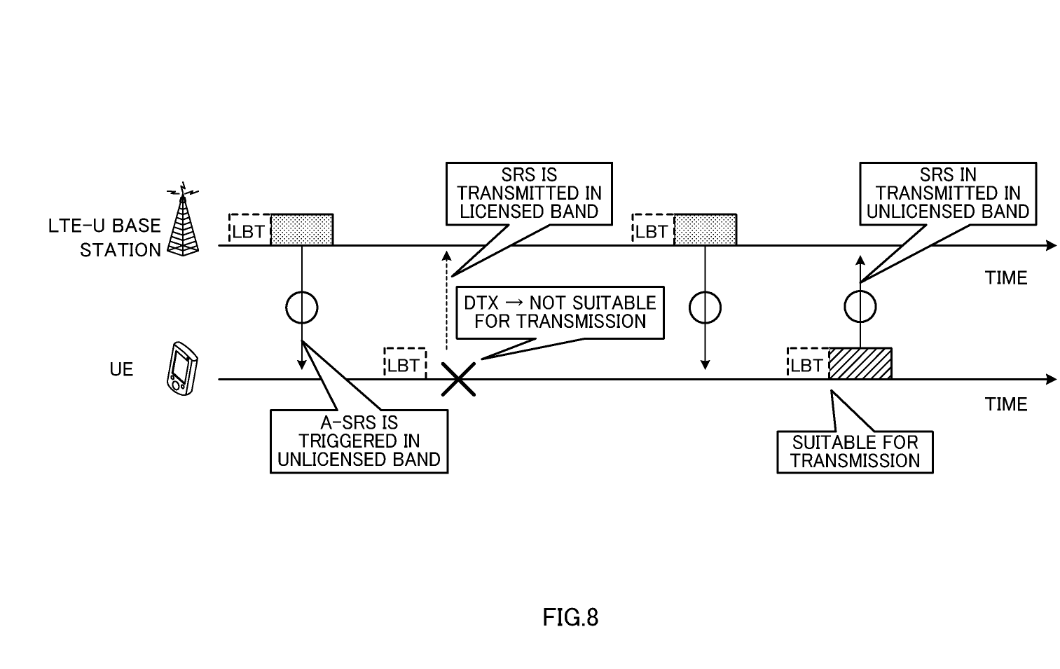

A user terminal can report an LBT result by using the SRS of a licensed band (see FIG. 8). For example, when a result of LBT in an unlicensed band says “not suitable for transmission,” the user terminal transmits an SRS in a predetermined resource in a licensed band. By using SRSs to report LBT results, it becomes possible to report LBT results with low overhead compared to the case of using the PUCCH.

Also, with the present embodiment, the reporting of LBT results may be controlled by using aperiodic SRS (A-SRS) trigger bits, which are contained in UL grants that command transmission of UL data signals (PUSCH signals).

In a UL grant (for example, DCI format 0/4) transmitted from the radio base station in the unlicensed band, an A-SRS trigger bit for making the user terminal transmit an SRS is included. Usually, an A-SRS trigger bit triggers an SRS in the same frequency band as the PUSCH. That is to say, an unlicensed band UL grant triggers transmission of an unlicensed SRS.

With the present embodiment, the SRS transmitting frequency band is changed, depending on the result of LBT, by using the A-SRS trigger that is included in a UL grant of an unlicensed band (see FIG. 8). For example, when a user terminal properly receive a UL grant that is transmitted in an unlicensed band and the result of LBT says “suitable for transmission,” the user terminal transmits an SRS in an unlicensed band (normal SRS operation).

On the other hand, when the user terminal receives the UL grant transmitted in the unlicensed band properly and yet the result of LBT says “not suitable for transmission,” the user terminal transmits an SRS in a licensed band (LBT result reporting). When the radio base station triggers an A-SRS in the unlicensed band and receives an SRS in the licensed band, the radio base station can judge that the LBT result in the user terminal is one that says “not suitable for transmission.”

Note that SRS resources of the licensed band and SRS resources of the unlicensed band can be reported to user terminals, in advance, through higher layer signaling (for example, RRC signaling and so on).

In this way, by using A-SRS triggers and changing the SRS transmitting frequency band depending on LBT results, it is possible to use the SRS as an unlicensed band reference signal (sounding signal) when the unlicensed band is “suitable for transmission.” Meanwhile, the SRS can be used as an LBT result-reporting signal when the unlicensed band is “not suitable for transmission,” so that it is possible to make effective use of the SRS. Also, existing UL grant information bits are re-used as an LBT result-reporting SRS trigger, so that it is possible to reduce the increase of the payload size.

<PUSCH>

A user terminal can report LBT results by using the PUSCH of a licensed band as well. For example, when the PUSCH of a licensed band is allocated in the timing to report a result of LBT, the user terminals multiplexes the LBT result on this licensed band PUSCH in the timing to report the LBT result, and transmits this. On the other hand, a structure may be employed in which, if the PUSCH of the licensed band is not allocated in the timing to report the LBT result, the user terminal does not report the LBT result.

Note that, as for the timing to report the result of LBT, when the LBT result says “suitable for transmission,” the subframe timing where the LBT result was planned to be transmitted in the unlicensed band can be used.

In this way, by transmitting LBT results using the PUSCH of a licensed band, it is not necessary to prepare new dedicated resources for reporting LBT results, so that it is possible to reduce the decrease of the efficiency of the use of resources. Also, the radio base station can make the process of assigning scheduling for configuring LBT result-reporting resources unnecessary.

Also, when the radio base station wants a user terminal to report an LBT result, licensed band and unlicensed band UL data signal transmission commands (UL grants) can be configured in the same timing. By this means, when a result of LBT in the unlicensed band says “not suitable for transmission,” the user terminal can report the LBT result by using the PUSCH of the licensed band.

### Second Example

A case will be described with a second example where a result of LBT, performed by a user terminal in an unlicensed band (for example, “not suitable for transmission”), is reported by using a MAC control element (MAC CE: Medium Access Control Control Element). The MAC control element refers to control information that is used in MAC layer control.

When a result of LBT says “not suitable for transmission” the user terminal transmits the LBT result by using the MAC CE of a licensed band, in a predetermined timing. For example, if the PUSCH of the licensed band is allocated in the timing to report a result of LBT, the user terminal multiplexes the LBT result on the MAC CE when the PUSCH of the licensed band is transmitted. On the other hand, a structure may as well be employed in which, if the PUSCH of the licensed band is not allocated in the timing to report the LBT result, the LBT result is not multiplexed on the MAC CE in this reporting timing.

Note that, as for the timing to report the result of LBT, as noted earlier, when the LBT result says “suitable for transmission,” the subframe timing where the LBT result was planned to be transmitted in the unlicensed band can be used. Also, as with the existing power headroom report (PHR) for LTE, an LBT result report trigger may be provided based on a timer.

In this way, by multiplexing LBT results on MAC CEs in predetermined timings and sending reports, it is not necessary to prepare new dedicated resources for reporting LBT results, so that it is possible to reduce the decrease of the efficiency of the use of resources. Also, the radio base station can make the process of assigning scheduling for configuring LBT result-reporting resources unnecessary.

Also, when the radio base station wants a user terminal to report an LBT result, licensed band and unlicensed band UL data signal transmission commands (UL grants) can be configured in the same timing. Furthermore, since the user terminal reports information related to the LBT result (for example, “not suitable for transmission”) in the MAC header, it is possible to make the payload of uplink data less pressing.

Note that, when LBT results are reported using MAC CEs, several past LBT results may be reported in one result transmitted. By so doing, the radio base station side can know the average LBT result of the past, in addition to the most recent LBT result, so that it is possible to learn a user terminal's environment, state of interference and so on.

### Third Example

A case will be described with a third example where a result of LBT performed by a user terminal in an unlicensed band is reported in the form of a measurement report by using the PUSCH of a licensed band. In this case, the user terminal may report, not only the LBT result (“suitable for transmission”/“not suitable for transmission”), but also whether or not there are unlicensed band signals from other communication systems (for example, Wi-Fi and other operators' LTE-U), together.

To be more specific, as a measurement report to use the PUSCH of a licensed band, the user terminal can report information about the received power in each LBT timing, in addition to an LBT result. Information about the received power in an LBT timing may be the average value of the received power of LTE signals, the sum power of RSRPs from other cells, and/or the average value of transmitting/received power (RSSI) and so on.

By using a measurement report, the radio base station can learn the situation regarding the use of frequency channels over a certain length of period (of the order of several hundred ms), and decide whether or not to allocate DL/UL transmission in an unlicensed band. For example, when the volume of traffic in the unlicensed band is heavy according to a measurement report from a user terminal, the radio base station can stop assigning DL/UL transmission in the unlicensed band or switch the frequency.

Also, when, in the unlicensed band, interference from LTE signals is predominant and an LBT result to say “not suitable for transmission” is yielded, it is possible to relax the condition of transmission in the unlicensed band on the user terminal side and configure a state in which transmission is possible. This is because LTE systems are superior to other communication systems such as Wi-Fi and others in terms of receiver functions.

Note that, when a result of LBT is reported in the form of a measurement report, it is equally possible to find the average of several past LBT results and report this in one result transmission. By this means, the radio base station side can know the average result of LBT in the past, and, consequently, learn the user terminal's environment, state of interference and so on.

### Fourth Example

TPC commands for controlling UL transmission power are included in downlink control signals (UL grants) that control UL signal (for example, PUSCH signal) transmission commands for user terminals. Usually, when a user terminal receives a UL grant properly in a licensed band, the user terminal mirrors the TPC command included in the UL grant on the UL signal transmission power.

Meanwhile, as described above, even when a user terminal receives a UL grant properly in an unlicensed band (LAA), cases still might occur where no UL signal (for example, PUSCH signal) is transmitted (for example, when the result of LBT says “not suitable for transmission”). Also, the user terminal applies control by accumulating the TPC commands reported in UL grants. Consequently, when the TPC commands in UL grants that are transmitted in the unlicensed band keep being mirrored on the transmission power control for the PUSCH of the unlicensed band, there is a threat that the transmission power becomes excessive when an LBT result to say “suitable for transmission” is yielded.

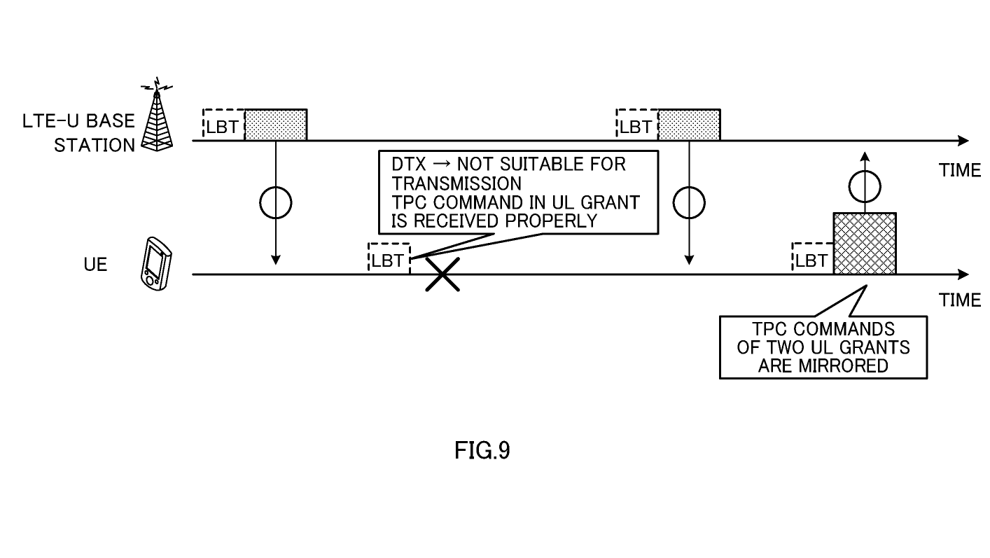

For example, as shown in FIG. 9, assume a case where a user terminal receives a UL grant properly in an unlicensed band and controls the UL transmission power based on the TPC command, and where the user terminal nevertheless does not carry out UL transmission based on the result of LBT. In this case, there is a threat that, if the LBT that is performed next yields a result that says “suitable for transmission,” TPC commands for two UL grants are mirrored, and the user terminal might carry out transmission with excessive power.

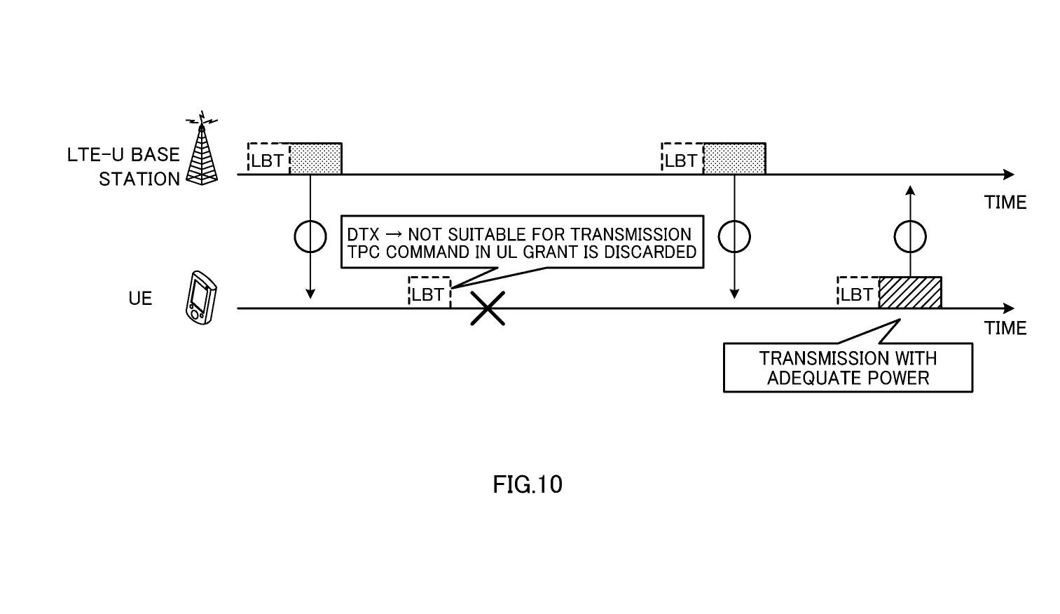

So, with the present embodiment, LBT results in an unlicensed band and the applying TPC commands, included in UL grants, are controlled in association with each other. To be more specific, when, as shown FIG. 10, a user terminal successfully receives a UL grant in an unlicensed band and yet the result of LBT says “not suitable for transmission,” the TPC command included in this UL grant is not mirrored, and discarded (not accumulated). That is, a TPC command is mirrored on transmission power (a TPC command is accumulated) only when a user terminal successfully receives a UL grant and the result of LBT says “suitable for transmission.”

In this way, by controlling LBT results in an unlicensed band and the applying TPC commands, included in UL grants, in association with each other, it becomes possible to control the UL transmission power in the unlicensed band adequately, regardless of the result of LBT.

(Structure of Radio Communication System)

Now, a structure of a radio communication system according to the present embodiment will be described below. In this radio communication system, the above-described radio communication methods according to the first to fourth examples are employed. Note that the above radio communication methods of the first to fourth examples may be applied individually, or may be applied in combination.

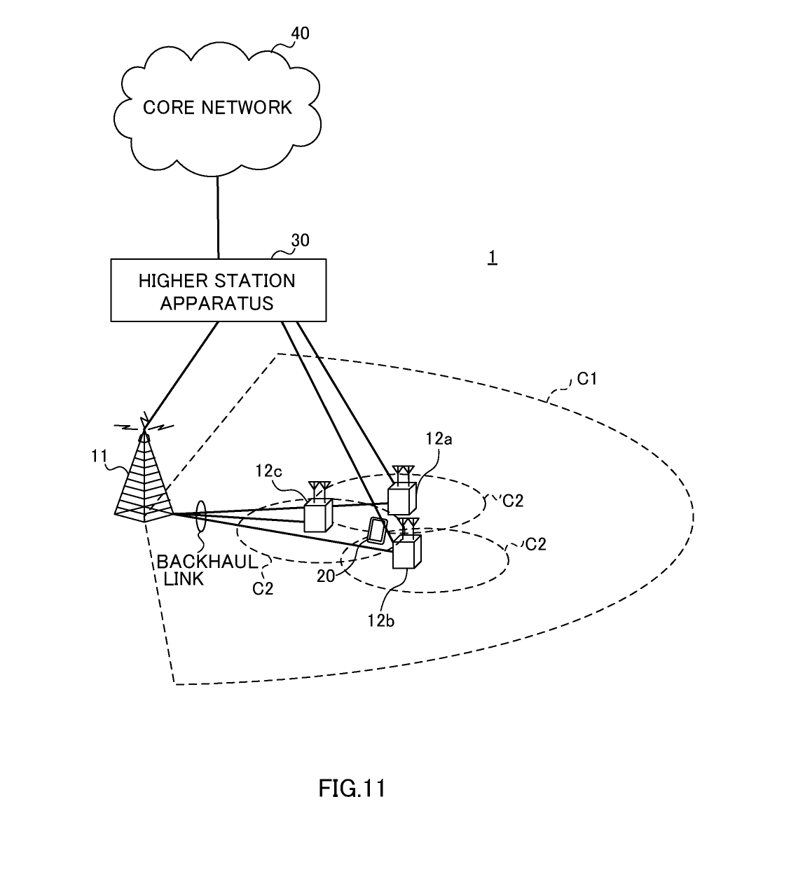

FIG. 11 is a schematic configuration diagram of a radio communication system according to the present embodiment. Note that the radio communication system shown in FIG. 11 is for example, an LTE system, or a system to accommodate SUPER 3G. This radio communication system can adopt carrier aggregation (CA) to group a plurality of fundamental frequency blocks (component carriers) into one, where the LTE system bandwidth constitutes one unit. Also, the radio communication system can use a licensed band and an unlicensed band. Note that this radio communication system may be referred to as “IMT-advanced,” or may be referred to as “4G,” “FRA” (Future Radio Access), etc.

The radio communication system 1 shown in FIG. 11 includes a radio base station 11 that forms a macro cell C1, and radio base stations 12a to 12c that form small cells C2, which are placed within the macro cell C1 and which are narrower than the macro cell C1. Also, user terminals 20 are placed in the macro cell C1 and in each small cell C2. For example, a mode of use may be possible here in which the macro cell C1 is used in a licensed band and the small cells C2 are used in an unlicensed band (LTE-U).

Alternatively, a mode of use may be also possible in which the radio base station 11 uses a licensed band and an unlicensed band. In this case, the licensed band cell and the unlicensed band cell which the radio base station 11 forms may have different sizes.

The user terminals 20 can connect with both the radio base station 11 and the radio base stations 12. The user terminals 20 may use the macro cell C1 and the small cells C2, which use different frequencies, at the same time, by means of CA. For example, the radio base station 11 can transmit, to a user terminal 20, assist information that pertains to the radio base stations 12 (including, for example, an LTE-U base station).

Between the user terminals 20 and the radio base station 11, communication is carried out using a carrier of a relatively low frequency band (for example, 2 GHz) and a narrow bandwidth (referred to as, for example, “existing carrier,” “legacy carrier” and so on). Meanwhile, between the user terminals 20 and the radio base stations 12, a carrier of a relatively high frequency band (for example, 3.5 GHz, 5 GHz and so on) and a wide bandwidth may be used, Between the radio base station 11 and the radio base stations 12 (or between the radio base stations 12), wire connection (optical fiber, the X2 interface and so on) or wireless connection is established.

The radio base station 11 and the radio base stations 12 are each connected with a higher station apparatus 30, and are connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as an “eNodeB,” a “macro base station,” a “transmitting/receiving point” and so on. Also, the radio base stations 12 are radio base stations having local coverages, and may be referred to as “small base stations,” “pico base stations,” “femto base stations,” “home eNodeBs,” “RRHs” (Remote Radio Heads), “micro base stations,” “transmitting/receiving points” and so on. Hereinafter the radio base stations 11 and 12 will be collectively referred to as a “radio base station 10,” unless specified otherwise. The user terminals 20 are terminals to support various communication schemes such as LTE, LTE-A and so on, and may be either mobile communication terminals or stationary communication terminals.

In the radio communication system, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier transmission scheme to perform communication by dividing a frequency band into a plurality of narrow frequency bands (subcarriers) and mapping data to each subcarrier. SC-FDMA is a single-carrier transmission scheme to mitigate interference between terminals by dividing the system band into bands formed with one or continuous resource blocks per terminal, and allowing a plurality of terminals to use mutually different bands.

Here, communication channels used in the radio communication system shown in FIG. 11 will be described. Downlink communication channels include a PDSCH (Physical Downlink Shared CHannel), which is used by each user terminal 20 on a shared basis, and downlink L1/L2 control channels (PDCCH, PCFICH, PHICH and enhanced PDCCH). User data and higher control information are communicated by the PDSCH. Scheduling information for the PDSCH and the PUSCH and so on are communicated by the PDCCH (Physical Downlink Control CHannel). The number of OFDM symbols to use for the PDCCH is communicated by the PCFICH (Physical Control Format Indicator CHannel). HARQ ACKs/NACKs for the PUSCH are communicated by the PHICH (Physical Hybrid-ARQ Indicator CHannel). Also, the scheduling information for the PDSCH and the PUSCH and so on may be communicated by the enhanced PDCCH (EPDCCH) as well. This EPDCCH is frequency-division-multiplexed with the PDSCH (downlink shared data channel).

Uplink communication channels include a PUSCH (Physical Uplink Shared CHannel), which is used by each user terminal 20 on a shared basis as an uplink data channel, and a PUCCH (Physical Uplink Control CHannel), which is an uplink control channel. User data and higher control information are communicated by this PUSCH. Also, by the PUCCH, downlink radio quality information (CQI), delivery acknowledgement signals (ACK/NACK) and so on are communicated.

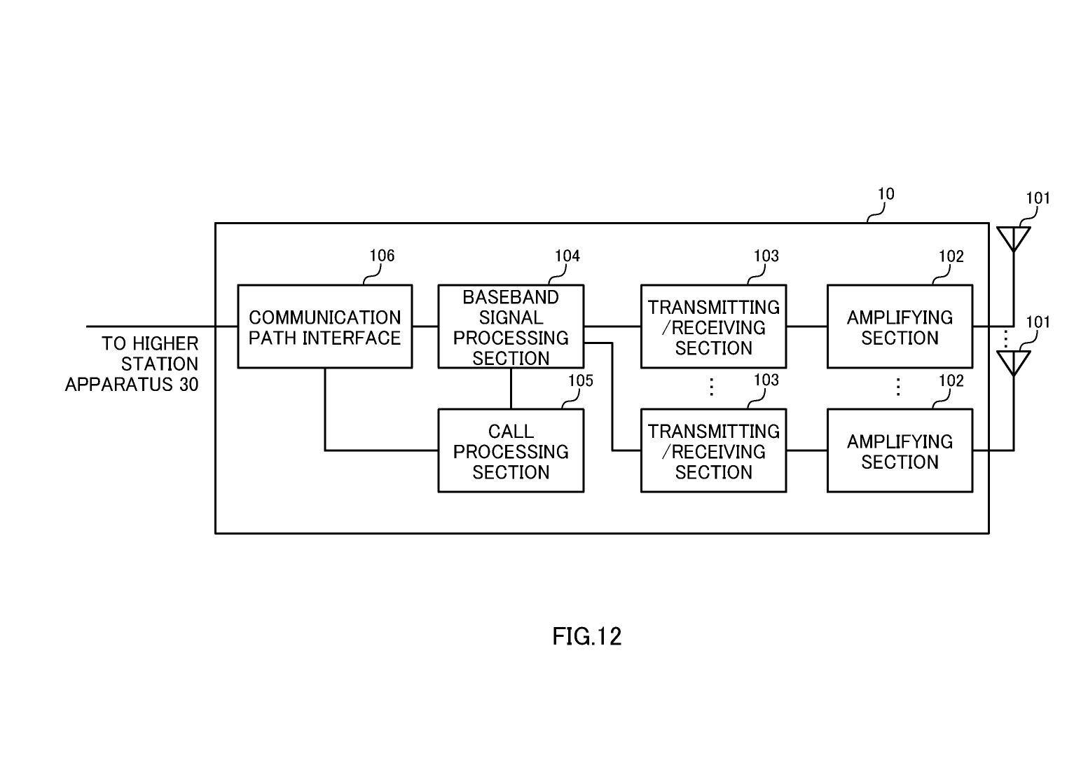

FIG. 12 is a diagram to show an overall structure of a radio base station 10 (which may be either a radio base station 11 or a radio base station 12) according to the present embodiment. The radio base station 10 has a plurality of transmitting/receiving antennas 101 for MIMO communication, amplifying sections 102, transmitting/receiving sections (transmitting sections/receiving sections) 103, a baseband signal processing section 104, a call processing section 105, and a communication path interface 106.

User data to be transmitted from the radio base station 10 to a user terminal 20 on the downlink is input from the higher station apparatus 30 to the baseband signal processing section 104, via the communication path interface 106.

In the baseband signal processing section 104, a PDCP layer process, division and coupling of user data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process and a precoding process are performed, and the result is forwarded to each transmitting/receiving section 103. Furthermore, downlink control channel signals are also subjected to transmission processes such as channel coding and an inverse fast Fourier transform, and forwarded to each transmitting/receiving section 103.

Also, the baseband signal processing section 104 reports, to the user terminal 20, control information (system information) for allowing communication in the cell, through higher layer signaling (RRC signaling, broadcast information and so on). The information for allowing communication in the cell includes, for example, the uplink or downlink system bandwidth and so on.

Also, information about the radio resources (for example, PUCCH resources and so on) for allocating unlicensed band LBT results may be transmitted from the radio base station 10 to the user terminals.

Each transmitting/receiving section 103 converts baseband signals, which are pre-coded and output from the baseband signal processing section 104 on a per antenna basis, into a radio frequency band. The amplifying sections 102 amplify the radio frequency signals having been subjected to frequency conversion, and transmit the signals through the transmitting/receiving antennas 101.

On the other hand, as for data to be transmitted from the user terminals 20 to the radio base station 10 on the uplink, radio frequency signals that are received in the transmitting/receiving antennas 101 are each amplified in the amplifying sections 102, converted into the baseband signal through frequency conversion in each transmitting/receiving section 103, and input in the baseband signal processing section 104.

In the baseband signal processing section 104, the user data that is included in the input baseband signal is subjected to an FFT process, an IDFT process, error correction decoding, a MAC retransmission control receiving process, and RLC layer and PDCP layer receiving processes, and the result is forwarded to the higher station apparatus 30 via the communication path interface 106. The call processing section 105 performs call processing such as setting up and releasing communication channels, manages the state of the radio base stations 10 and manages the radio resources.

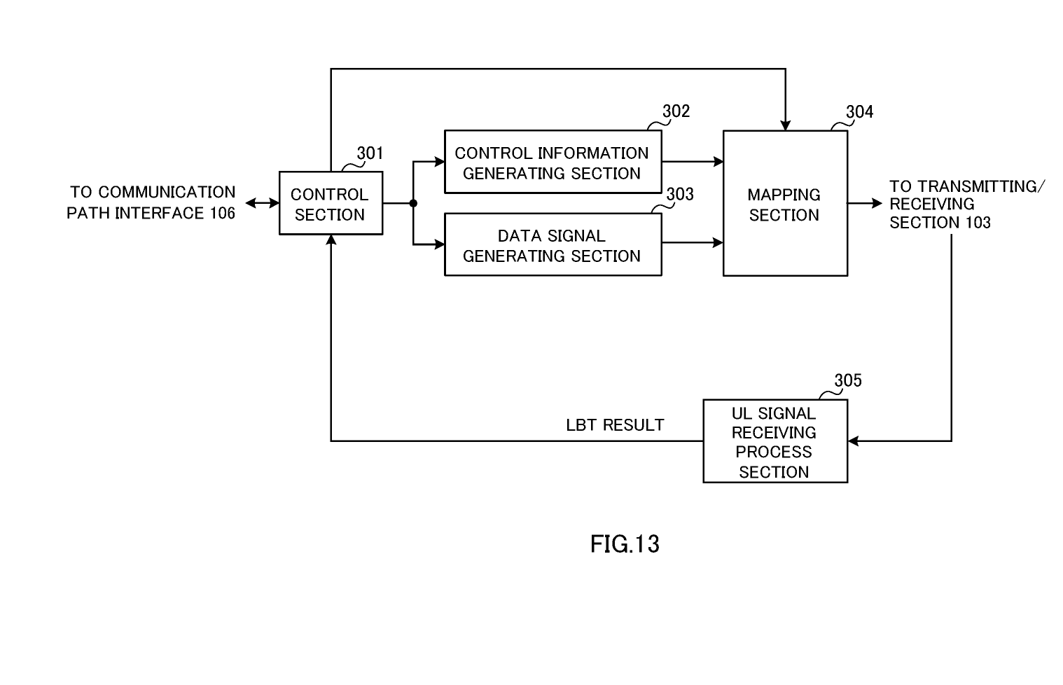

FIG. 13 is a diagram to show a principle functional structure of the baseband signal processing section 104 provided in the radio base station 10 according to the present embodiment. Note that, although FIG. 13 primarily shows function blocks corresponding to the characteristic part of the present embodiment, assume that the radio base station 10 also has other function blocks that are required for radio communication.

As shown in FIG. 13, the radio base station 10 has a control section 301 (scheduler), a control information generating section 302, a data signal generating section 303, a mapping section 304, and a UL signal receiving process section 305.

The control section 301 controls the scheduling of downlink data signals transmitted in the PDSCH and downlink control signals (UL grants, DL assignments, etc.) that are transmitted in the PDCCH and/or the enhanced PDCCH (EPDCCH). Furthermore, the control section 301 controls the scheduling of downlink reference signals such as system information, synchronization signals, CRSs, CSI-RSs and so on.

For example, the control section 301 controls the transmission of UL signals (for example, PUCCH signals) by the user terminals in an unlicensed band and/or a licensed band, and commands the control information generating section 302 to generate UL grants. Also, the control section 301 controls UL signal transmission (adaptive control) based on whether or not UL signals are received from user terminals where UL transmission is commanded. When doing so, the control section 301 controls the transmission of UL signals (for example, adaptive control and so on) taking into account the results of LBT that are transmitted from the user terminals by using the licensed band.

The control information generating section 302 generates control information based on commands from the control section 301. For example, the control information generating section 302 generates UL grants (for example, DCI format 0/4), which command the user terminals to transmit UL data signals. Aperiodic SRS trigger bits and so on can be included in UL grants.

The data signal generating section 303 generates downlink data signals (PDSCH signals). Also, the mapping section 304 controls the mapping of DL signals based on commands from the control section 301.

The UL signal receiving process section 305 applies receiving processes (for example, decoding, data demodulation and so on) to the UL signals transmitted from the user terminal. The UL signal receiving process section 305, when detecting an LBT result (for example, “not suitable for transmission”) that is transmitted from a user terminal by using the licensed band, outputs this to the control section 301.

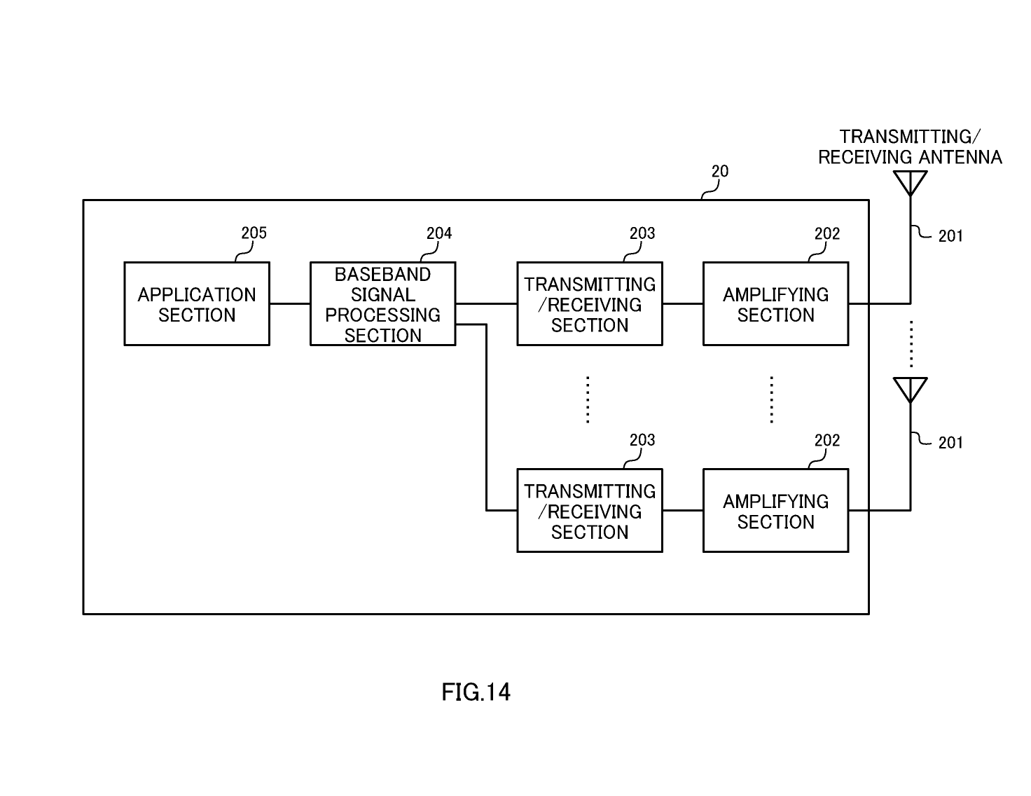

FIG. 14 is a diagram to show an overall structure of a user terminal 20 according to the present embodiment. The user terminal 20 has a plurality of transmitting/receiving antennas 201 for MIMO communication, amplifying sections 202, transmitting/receiving sections 203 (transmitting sections/receiving sections) 203, a baseband signal processing section 204 and an application section 205.

As for downlink data, radio frequency signals that are received in the plurality of transmitting/receiving antennas 201 are each amplified in the amplifying sections 202, and subjected to frequency conversion and converted into the baseband signal in the transmitting/receiving sections 203. This baseband signal is subjected to receiving processes such as an FFT process, error correction decoding and retransmission control (HARQ-ACK), in the baseband signal processing section 204. In this downlink data, downlink user data is forwarded to the application section 205. The application section 205 performs processes related to higher layers above the physical layer and the MAC layer. Also, in the downlink data, broadcast information is also forwarded to the application section 205.

Meanwhile, uplink user data is input from the application section 205 to the baseband signal processing section 204. In the baseband signal processing section 204, a retransmission control (HARQ-ACK) transmission process, channel coding, precoding, a DFT process, an IFFT process and so on are performed, and the result is forwarded to each transmitting/receiving section 203. The baseband signal that is output from the baseband signal processing section 204 is converted into a radio frequency band in the transmitting/receiving sections 203. After that, the amplifying sections 202 amplify the radio frequency signal having been subjected to frequency conversion, and transmit the resulting signal from the transmitting/receiving antennas 201.

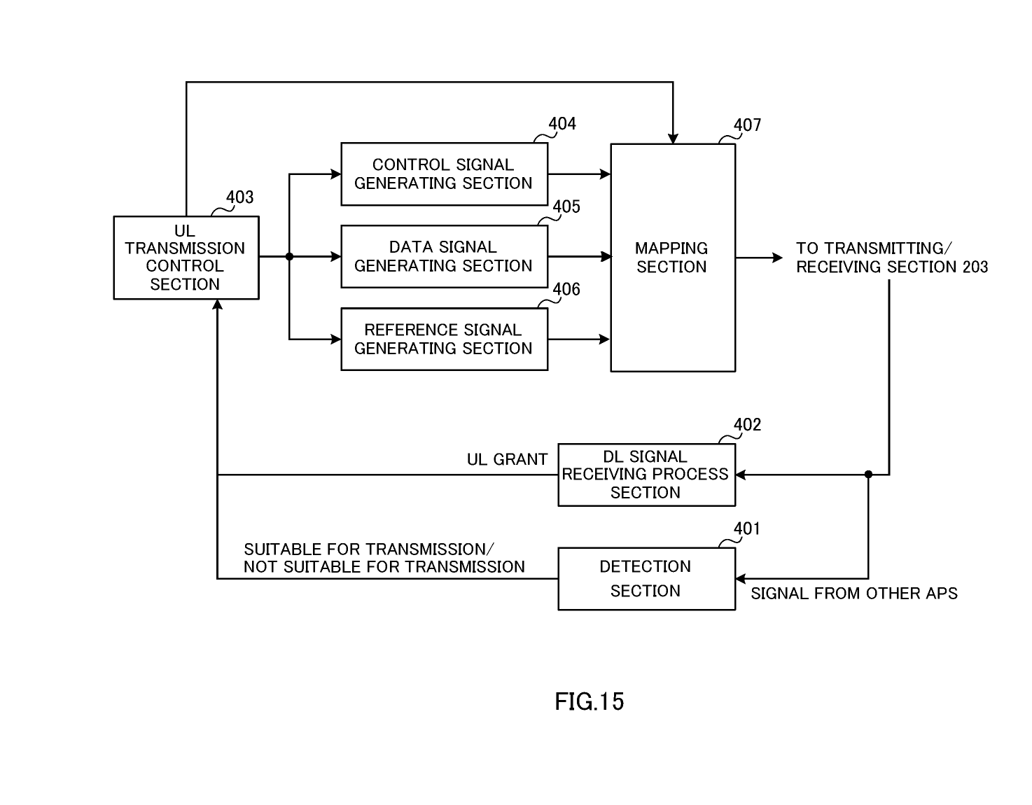

FIG. 15 is a diagram to show a principle functional structure of the baseband signal processing section 204 provided in the user terminal 20. Note that, although FIG. 15 primarily shows function blocks corresponding to the characteristic part of the present embodiment, assume that the user terminal 20 also has other function blocks that are required for radio communication.

As shown in FIG. 15, the baseband signal processing section 204 provided in the user terminal 20 has a detection section 401, a DL signal receiving process section 402, a UL transmission control section 403 (control section), a control signal generating section 404, a data signal generating section 405, a reference signal generating section 406 and a mapping section 407.

The detection section 401 detects signals (LBT) that are transmitted from other transmission points (APs) in the unlicensed band. To be more specific, the detection section 401 detects/measures signals from other transmission points in a predetermined timing (for example, in a timing to perform LBT) and outputs the result of this detection/measurement operation to the UL transmission control section 403. When doing so, the detection section 401 may send a report to the UL transmission control section 403 only when a detected signal exhibits a power level that is equal to or higher than a predetermined threshold.

The DL signal receiving process section 402 performs receiving processes (decoding, demodulation and so on) of DL signals transmitted in the licensed band or the unlicensed band. For example, the DL signal receiving process section 402 acquires the UL grant that is included in a downlink control signal (for example, DCI format 0/4), and outputs this to the UL transmission control section 403.

The UL transmission control section 403 controls the transmission of UL signals (UL data signals, UL control signals, reference signals and so on) to the radio base station in the licensed band and the unlicensed band. Also, the UL transmission control section 403 controls the transmission in the unlicensed band based on detection results (LBT results) in the detection section 401. That is, the UL transmission control section 403 controls the transmission of UL signals in the unlicensed band by taking into account the UL transmission commands (UL grants) transmitted from the radio base station and the detection results (LBT results) yielded in the detection section 401.

Also, the UL transmission control section 403 applies control so that information (for example, “not suitable for transmission”) about the detection results (LBT results) in the detection section 401 is reported to the radio base station by using the licensed band. When so doing, if a result of LBT in the unlicensed band says “not suitable for transmission,” the UL transmission control section 403 applies control so that information about the LBT result is transmitted from the transmitting/receiving section 203 in the timing where a UL signal was planned to be transmitted in the unlicensed band.

Also, when the LBT result is transmitted using the PUCCH of the licensed band, the UL transmission control section 403 determines the PUCCH resource to allocate the LBT result, based on information that is provided through higher layer signaling or that is commanded in a UL grant transmitted in the unlicensed band, and reports this PUCCH resource to the mapping section 407.

Also, when the LBT result says “not suitable for transmission,” the UL transmission control section 403 applies control so that, based on an aperiodic SRS trigger that is included in a UL grant in the unlicensed band, an SRS is transmitted in the licensed band.

Also, when the result of LBT says “not suitable for transmission,” the UL transmission control section 403 applies control so that, if the PUSCH of the licensed band is allocated in the transmission timing where a UL signal was planned to be transmitted in the unlicensed band, the LBT result is multiplexed on this PUSCH and transmitted.

Also, the UL transmission control section 403 may also apply control so that information about the LBT result is transmitted by using a MAC CE or a measurement report. At this time, the UL transmission control section 403 may report several past LBT results in one result that is transmitted. By this means, the radio base station 10 can know the average LBT result of the past, in addition to the most recent LBT result, and therefore can learn the environment, the state of interference and so on of the user terminal 20.

The control signal generating section 404 generates a UL control signal (PUCCH signal). Also, the control signal generating section 404 can generate PUCCH signals with unlicensed band LBT results included therein, based on commands from the UL transmission control section 403.

The data signal generating section 405 generates UL data signals (PUCCH signals) based on UL grants transmitted from the radio base station. The data signal generating section 405 generates UL data signals (PUCCH signals) based on UL grants transmitted from the radio base station.

The reference signal generating section 406 generates UL reference signals (SRS, CSI and so on). Also, the reference signal generating section 406 can generate UL reference signals with LBT results included therein, based on commands from the UL transmission control section 403.

The mapping section 407 maps the UL signals based on commands from the UL transmission control section 403. Also, when an result of LBT in the unlicensed band says “not suitable for transmission,” the mapping section 407 allocates information about this LBT result to a radio resource of the licensed band.

Also, the user terminal 20 may have a power control section for controlling whether or not to apply the power control commands included in unlicensed band UL transmission commands, based on LBT results in the unlicensed band.

As described above, with the present embodiment, when LBT is supported in UL transmission in LTE-U, LBT results in an unlicensed band are reported from a user terminal to a radio base station by using a licensed band. By this means, when no UL transmission takes place from a user terminal where UL transmission is commanded, the radio base station side can learn the accurate reason (the type of DTX), and, as a result of this, the radio base station can apply adequate UL transmission control.

Now, although the present invention has been described in detail with reference to the above embodiment, it should be obvious to a person skilled in the art that the present invention is by no means limited to the embodiment described herein. The present invention can be implemented with various corrections and in various modifications, without departing from the spirit and scope of the present invention defined by the recitations of claims. For example, a plurality of examples described above may be combined and implemented as appropriate. Consequently, the description herein is only provided for the purpose of illustrating examples, and should by no means be construed to limit the present invention in any way.

The disclosure of Japanese Patent Application No. 2014-056967, filed on Mar. 19, 2014, including the specification, drawings and abstract, is incorporated herein by reference in its entirety.

1. A user terminal that communicates with a radio base station by using a licensed band and an unlicensed band, the user terminal comprising:
a detection section that detects a signal transmitted from another transmission point in the unlicensed band;
a control section that controls transmission of a UL signal in the unlicensed band based on a UL transmission command transmitted from the radio base station and the detection result in the detection section; and
a transmission section that transmits the UL signal,
wherein the transmission section transmits information related to the detection result to the radio base station by using the licensed band.

2. The user terminal according to claim 1, wherein the transmission section transmits the information related to the detection result by using a physical channel and/or a UL reference signal of the licensed band.

3. The user terminal according to claim 1, wherein, when the transmission section does not transmit the UL signal in the unlicensed band based on the detection result, the transmission section transmits the information related to the detection result in a transmission timing where the UL signal was planned to be transmitted in the unlicensed band.

4. The user terminal according to claim 2, wherein the control section allocates the information related to the detection result to a predetermined uplink control channel resource (PUCCH: Physical Uplink Control CHannel resource) of the licensed band based on information that is commanded in higher layer signaling or in a UL grant that is transmitted in the unlicensed band.

5. The user terminal according to claim 2, wherein, when the transmission section does not transmit the UL signal in the unlicensed band based on the detection result, the transmission section transmits a UL reference signal in the licensed band based on a UL reference signal trigger included in a UL transmission command in the unlicensed band.

6. The user terminal according to claim 2, wherein, when the transmission section does not transmit the UL signal in the unlicensed band based on the detection result and an uplink shared channel (PUSCH: Physical Uplink Shared Channel) of the licensed band is allocated in a transmission timing where the UL signal was planned to be transmitted in the unlicensed band, the transmission section multiplexes and transmits the information related to the detection result on the uplink shared channel.

7. The user terminal according to claim 1, wherein the transmission section transmits the information related to the detection result by using a MAC CE (MAC Control Element) or a measurement report.

8. The user terminal according to claim 1, further comprising a power control section that controls UL transmission power in the unlicensed band, wherein the power control section controls whether or not to apply a power control command included in the UL transmission command of the unlicensed band based on the detection result.

9. A radio base station that communicates with a user terminal by using a licensed band and an unlicensed band, the radio base station comprising:
a transmission section that transmits a UL grant, which commands transmission of a UL signal in the unlicensed band, to the user terminal;
a receiving section that receives the UL signal transmitted from the user terminal; and
a control section that controls transmission of the UL signal based on whether or not the UL signal is received from the user terminal where UL transmission is commanded,
wherein, when the user terminal controls whether or not to transmit the UL signal in the unlicensed band based on a detection result of a signal transmitted from another transmission point in the unlicensed band, the control section controls the transmission of the UL signal based on information related to the detection result reported from the user terminal.

10. A radio communication method for a user terminal that communicates with a radio base station by using a licensed band and an unlicensed band, the radio communication method comprising:
detecting a signal transmitted from another transmission point in the unlicensed band;
controlling transmission of a UL signal in the unlicensed band based on a UL transmission command transmitted from the radio base station and the detection result; and
transmitting information related to the detection result to the radio base station by using the licensed band.
